(19) United States
(12) Patent Application Publication
(10) Pub. No.: US 2002/0087391 A1
(43) Pub. Date: Jul. 4, 2002

(54) System and method for consultative proposals

(76) Inventor: Michael Williams, Minneapolis, MN (US)

Correspondence Address: Daniel G. Chapik, DORSEY & WHITNEY LLP, Suite 1500, 50 South Sixth Street, Minneapolis, MN, 55402-1498, US

(21) Appl. No.: 10/007,612

(22) Filed: Nov. 9, 2001

Related U.S. Application Data
(60) Provisional application No. 60/247,156, filed on Nov. 10, 2000.

(51) Int. Cl. G06F 17/60

(52) U.S. Cl. 705/10

(57) ABSTRACT

A fleet manager or other user accesses a system for providing information regarding fleet management services. A relatively short list of questions are presented and the fleet manager or other user submits answers to those questions. The system, based upon those answers, generates a consultative proposal illustrating where the fleet management company could save money. The consultative proposal is based upon calculation done with the answers provide and certain static promotional material resident on the system. The system may be provided on a network wherein the fleet manager or other user can remotely access the system, provide their information and almost immediately receive a customized consultative proposal.

### CROSS-REFERENCE TO RELATED APPLICATION(S)

This application claims priority from U.S. Provisional Application No. 60/247,156, filed Nov. 10, 2000 entitled, “SYSTEM AND METHOD FOR CONSULTATIVE PROPOSALS,” which is hereby incorporated by reference in its entirety.

### FIELD OF THE INVENTION

The present invention relates generally to a method and system for providing automated quotes. More particularly, the invention relates to a method and system for providing constant quotes relating to a vehicle or equipment fleet.

### BACKGROUND OF THE INVENTION

Businesses often operate a fleet of vehicles. Operation of a fleet of vehicles may provide reliable transportation for the company's workers that may present a more professional image than the personal cars of the company's employees. The fleet of vehicles may be purchased or leased by the company, or the company may administer the purchasing or leasing of the vehicles by its employees. The vehicles of the fleet may also be acquired through a fleet management company or through a dealership. The company's financial situation, the size of the fleet, and the jobs that the vehicles are used for may affect how the vehicles are obtained and maintained.

One of the main factors a company may consider when operating a fleet of vehicles is cost. Depending on the nature of the business, the business may choose to spend money up front to purchase vehicles or may wish to lease vehicles to spread the cost over a longer period of time, or alternatively may choose to reimburse employees for their own decisions. Leasing vehicles may present an advantage in many instances because more capital is left to the company to be utilized in other manners, as well as the fact that the company does not have to worry about disposal of the vehicles when they have reached the end of their useful life. Other factors that may affect the expenses related to fleet vehicle management may include the types of leases, the types of vehicles obtained, how the vehicles are replaced, how the older vehicles are disposed, etc. Any one of these factors may affect the financial decisions of a company.

Maintenance of the fleet may be a further problem when utilizing a vehicle fleet. Maintenance of the vehicles may be handled by the company with the fleet, the company may contract with one service provider to perform all the necessary vehicle maintenance, a fleet management company may provide maintenance services, or the company operating the fleet may instead reimburse individual users for their maintenance expenses. Any of the above different options for fleet management may have a serious effect on the overall cost of the vehicle fleet. Other factors that may have an effect on the cost of maintaining a vehicle fleet may include policies relating to fuel expenses, registration, disposing of the vehicles, and financing of the original vehicle acquisition.

When the company is choosing what types of methods to use to maintain its fleet, the company may choose to work with a fleet management company to help control expenses. A fleet management company may specialize in helping a company choose what type of vehicles it acquires, how it acquires those vehicles, and how it maintains those vehicles. The fleet management may in effect be a surrogate administrative arm for the company which handles all of the fleet related problems. The fleet management company may lease the vehicle to the company or may simply provide services for vehicles the company that owns or leases.

If a company desires to analyze money saving options relating to its fleet of vehicles, the analysis may require substantial personnel and decision making time. For example, the company with the vehicle fleet may want an exact “lease vs. own” analysis for a specific cap cost requirement. Another example may be the company's desire to do a fuel cost analysis reflecting the miles per gallon of a new type of vehicle to be added to the fleet, or on vehicles the company already owns. Generating a study of cost saving approaches may require that a representative from the company perform an exhaustive study based on the company's prior experience with its fleet.

Other methods of analyzing costs and expenditures may include an analysis by a fleet management company. Analysis by a fleet management company may be advantageous in terms of better information and time saved, but may also pose problems such as having to wait for the generation of the consultative proposal. Analysis by a fleet management company may require an individual from the fleet answering forty or more different questions relating to their current, or contemplated, vehicle fleet. Once the questions are answered, a substantial number of calculations must then be performed to take different variables into consideration. These calculations may be time consuming for the fleet management company, to perform the calculations, to perform the analysis, and to put together the final proposal.

Costs associated with providing consultative cost saving solutions analysis to customers, or potential customers, may increase the cost for the fleet company to do business. High overhead for sales and marketing may be passed on to the customers of the fleet company.

### SUMMARY OF THE INVENTION

The present invention provides a method and system that allows a company to acquire detailed cost saving information for fleet related expenses in a quick, accurate, and easy manner. The system and method may also provide the company with the fleet a cost savings analysis on demand. In addition, a method and system are provided that require minimal customer input to formulate the consultative cost saving proposals. In addition, if the customized cost savings analysis provided to the customer can be quickly integrated with static information to form a complete customized proposal.

### BRIEF DESCRIPTION OF THE DRAWINGS

FIG. 1 is a block diagram illustrating a network configuration consistent with the principals of the present invention.

FIG. 2 is a block diagram illustrating a server configuration.

FIG. 3 is a flow chart illustrating a broad overview of a system and method consistent with the principals of the present invention.

FIG. 4 is an information gathering screen.

FIG. 5 is a continuation of the information gathering screen of FIG. 4.

FIG. 6 is a summary screen.

FIGS. 7-28 are a sample consultative proposal consistent with the principles of the present invention.

### DETAILED DESCRIPTION

One embodiment of the present invention allows a customer, or a potential customer, to receive a customized consultation in a timely and efficient manner. The customer may enter information into a database after being prompted by a series of questions. The customer may answer these questions based on a fleet of vehicles the customer currently operates, or may answer these questions based on changes to the fleet the customer is contemplating. Once the user has selected answers to the questions, the database may then perform certain calculations and provide the customer with a customized proposal for potential cost savings benefits in one or more fleet categories. The cost savings analysis may be done in various cost savings categories, for example, but not limited to, vehicle acquisition, financing, maintenance, fuel, registration costs, and vehicle resale. The calculated cost savings information may then be integrated into a static presentation to produce a customized consultative report. Generation of such a report automatically and in such a short period off time may provide an advantage to customers. The cost savings projections may be displayed to the customer in a format that can be stored on a computer, printed, or sent through the mail. The system may save the customer and the fleet management company both time and money.

As described herein, a “client” is any individual, person working for a company, company, or other entity that maintains or helps to maintain a vehicle fleet. The client may be the person assigned by a company to evaluate cost saving measures related to the fleet. The client may be directly associated with the company that has the fleet or may be an outside consultant or fleet manager that works for the client. A “user” is simply an individual client who is accessing the system. Finally the company that provides the customized report, and is promoting its services as a cost saving measure for the client, may be referred to as the “fleet management company,” the “fleet company,” the “fleet services provider,” or the “quote provider.” The client may work for a company evaluating the advantages of forming a business association with the fleet company for fleet management services.

The present invention is applicable to various computing environments, including network environments. In one embodiment, the present invention utilizes the Internet. The Internet is widely used today for a variety of applications. The Internet is a collection of computer networks that allows computer users to share files and other computer resources. Each computer connected to the Internet has a unique address whose format is defined by the Internet Protocol (“TCP/IP”). The Internet includes a public network using the TCP/IP and includes two kinds of computers: servers, which provide information and documents; and clients, which retrieve and display documents and information for users. As will be appreciated by those of ordinary skill in the art, as used throughout this specification the term “client computer” refers to a client computer (or machine) on a network, or to a process or programs, such as Web browsers, which run on a client computer in order to facilitate network connectivity and communications. This specification will use the term “individual” or “user” when referring to a person using a client computer to access the server and enter fleet information. Similarly, the term “server” will be used throughout this specification to refer to a server computer or computer system on a network, including the database attached to the server for storing information.

The “World Wide Web” (“Web” or “WWW”) is that collection of servers on the Internet that utilize the Hypertext Transfer Protocol (“HTTP”). HTTP is a known application protocol that provides users access to resources, which may be information in different formats such as text, graphics, images, sound, video, Hypertext Markup Language (“HTML”), as well as programs. HTML is a standard page description language which provides basic document formatting and allows the developer to specify “links” to other servers and files. Links may be specified via a Uniform Resource Locator (“URL”). Upon specification of a link by the user, the client makes a TCP/IP request to a Web server and receives information, which may be another “Web page” that is formatted according to HTML. Users can also access other pages on the same or other servers by following instructions on the screen, entering certain data, or clicking on selected icons.

A typical Web page is an HTML document with text, “links” that a user may activate (e.g. “click on”), as well as embedded URL's pointing to resources, such as images, video or sound, that the client may activate to fully use the Web page in a browser. Furthermore, icons may be present which a user clicks on to submit usage information to the server, or to request information from the server. In some situations, these resources may not be located on the same server that provided the HTML document to the client. Furthermore, HTTP allows for the transmission of certain information from the client to a server. The server can then post this information on its web site, forward it on to another user or server, or save it to a database for later use.

Telephone interactive voice response systems (“IVR”) are another method widely used for entering information into a database. The IVR systems use computer software and voice recognition programs to run the system. Currently, many credit card companies use this type of system for their customer service functions. In this system a user will dial in using a 1-800 number or other number to place the call through a standard touch-tone telephone. Prompting the user may be normally done by asking the user to touch or say a number corresponding to the desired choice. Once dialed in the user may make a selection and is further prompted to listen to the requested information or to enter new information. The IVR user can enter information using the telephone keypad or by speaking the fleet information into the handset. This information may be read back by the IVR system in order to prompt the user to confirm that the information was correctly entered and understood by the database. The various embodiments may be utilized in this manner to gather the information necessary to create the consultative proposal. As may appreciated, utilizing an IVR system may require the mailing of the customized savings report to the client. Mailing such a report may be slower, but may still save the client time and money spent on a face to face meeting with the fleet management company.

As may be appreciated, the fleet management company may provide access to this system to already existing clients or to new clients it wishes to do business with. The fleet company may use the system as a tool to service existing clients in an continued effort to save the client money, or may allow access to anyone curious also the fleet company's cost saving abilities.

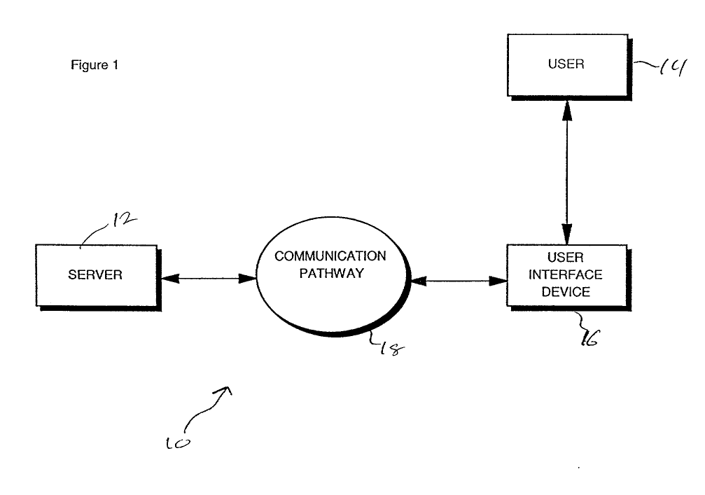

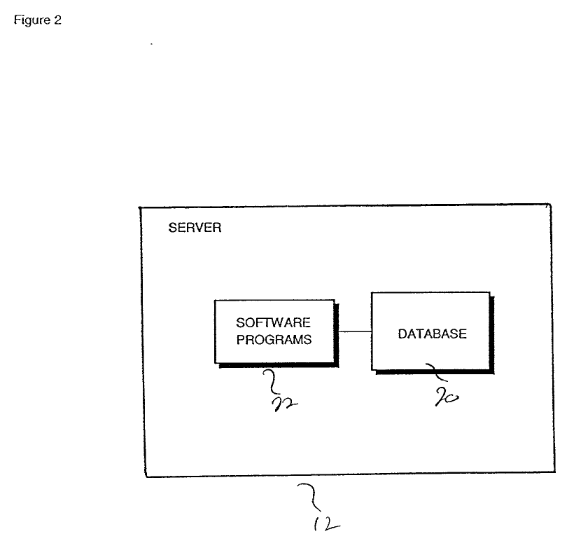

FIG. 1 is a block diagram illustration of a network environment 10 based on a client-server model. The network 10 comprises one or more servers 12, at least one user 14, a user interface device 16, and a communication pathway 18. The communication pathway 18 may be through the Internet or other suitable telecommunications path, such as an IVR. A suitable network protocol, such as the TCP/IP protocol, may be used for the communications. The interface device 16 may be any computer or web interface device known to those skilled in the art. The server 12 may also include the web server, which provides the computer information. The database 20 (see FIG. 2) may be part of the server 12. In alternative embodiments the database 20 and the server 12 may be set up in separate configurations. The user 14 utilizes an interface tool to access the system, to enter in the queried information, and to receive the customized report.

The interface device 16 may be any conventional computer known to those skilled in the art. The computer may comprise a central processor unit (“CPU”) and main memory, an input/output interface for communicating with various databases, files, programs, and networks (such as the internet), and one or more storage devices. The storage devices may be disk drive devices or CD ROM devices. The computer may also comprise a monitor or other screen device and an input device such as a keyboard and/or a mouse. In order to carry out the present invention over the Internet, the computer would also need to have some software programs contained in the main memory or the storage which can be used by the CPU.

A Web browser, which is a known software tool used to access the Web via a connection obtained through an Internet access provider, may be part of the software programs required. A variety of browsers known to those skilled in the art may be used within the scope of the present invention. As explained above, a Web server may allow access to so-called “Web sites” and “Web pages.” Once the Web browser has accessed these pages through the Web server, the HTML page may be downloaded through the input/output interface. The central processing unit will use the browser software package to interpret the information and display it on the monitor. The software may also contain other software or programs which will allow the user to fill in information on the screens and to exchange data with the server.

The memory or the storage device may also contain configuration software. This software will enable the computer to configure the downloaded HTML Web page to make it an interactive device. The configuration software may allow a user to move from one field to another on the downloaded Web page to select options or enter usage information.

FIG. 2 shows a possible server side 12. The “server” 12 may include both a database 20 and an automated environment, such as an IVR or an Internet server. The server 12 may automatically query the client for information and report that information to the database 20. The database 20 then does the calculations necessary to provide the customized consultative proposal. The database 20 then integrates the resulting information with static promotional materials to form the proposal. The database 20 then provides the customized proposal to the client through the server 12. In one embodiment, the server may send out web pages in HTML and/or Java script format for the user to download, interpret with his/her computer, and view on the monitor.

The server 12 may further contain additional software programs 22 which control the interface with the communications pathway 18 of FIG. 1. The software 22 also interfaces with database 20 to perform the various calculations, data storage and retrieval, format the derived information and send it to the user 14.

The server 12 that provides the HTML pages and other information may also include databases 20 and software 22 that perform calculations based on the client's input. The database 20 receives the information after querying the client for information and then uses that information into standard calculations to arrive at estimated current expenses for the client. The database 20 may then compare standard estimated costs of a client providing internal management of its fleet with estimated cost savings that the client company may achieve if it utilized the fleet company's services to arrive at total estimated cost savings. The server 12 may then integrate the database generated information, i.e. the dynamic cost saving information, with static promotional information meant to emphasize the potential cost savings. This information is then presented to the client for review and evaluation, providing a powerful, quick, and easy to use promotional tool at little or no cost to the fleet company.

The following description of the static and dynamic information presented in the customized consultative proposal is illustrated and described in terms of various screens. The information described herein may at first be presented as Internet screens displayed on the client's computer. These screens may be downloaded using a computer program, for example Adobe Acrobat®, and then printed off at the client site. In other embodiments, the customized consultative proposal may alternatively be printed at the fleet company's site and then sent through the mail to the client for analysis.

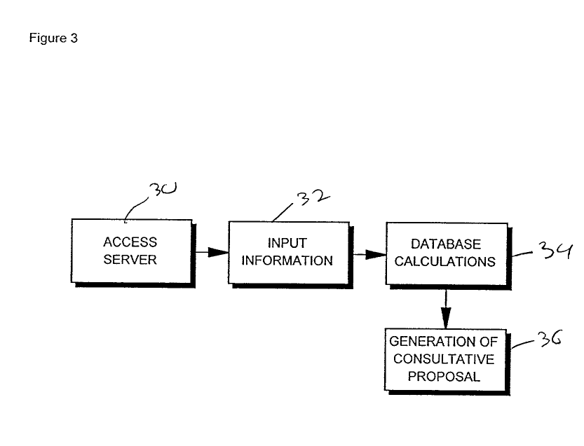

FIG. 3 is a flow chart illustrating a broad overview of one embodiment of the present invention. A user 14 accesses 30 the system through a server 12, inputs 32 information into the database 20 (directly or indirectly) by utilizing screens provided by the servers and generating a customized report. Various calculations 34 are performed and a proposal is generated 36.

The user 14 may initiate contact by logging in through an Internet site. Accessing the system may be done by typing in the proper URL address or hitting an appropriate link. In some cases, the user 14 may be solicited by an Internet advertisement or a mailer to the client. The user 14 may be any person associated with the fleet of the company that desires access to better information on possible cost saving measures related to vehicle and fleet expenditures.

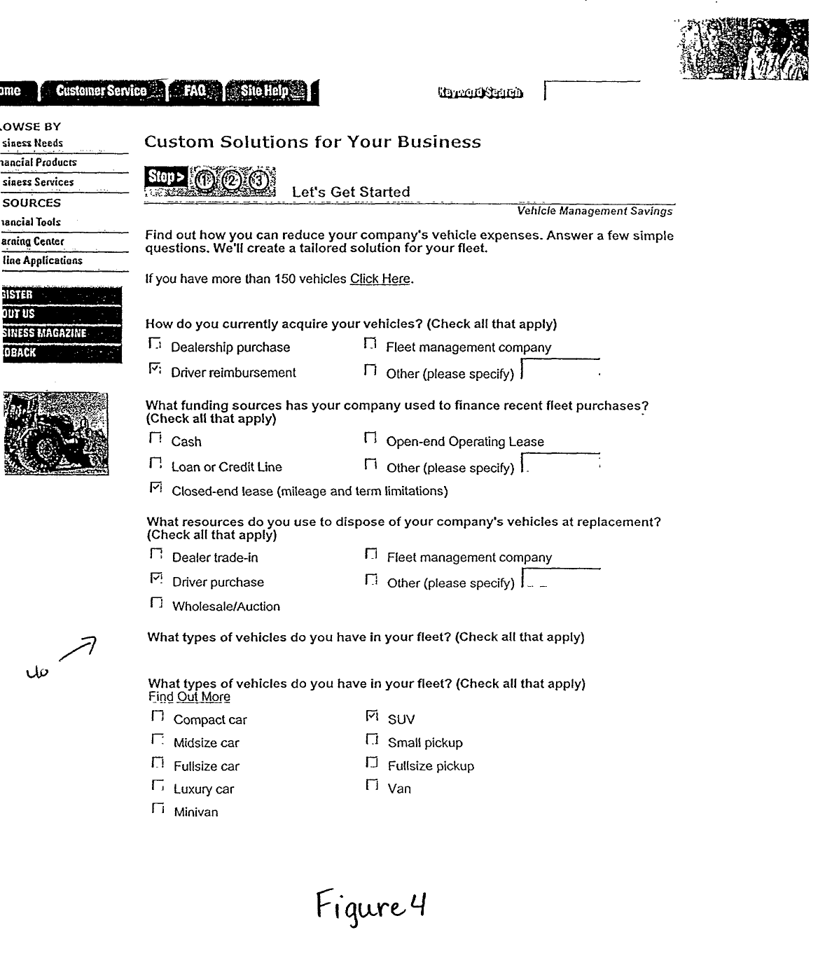

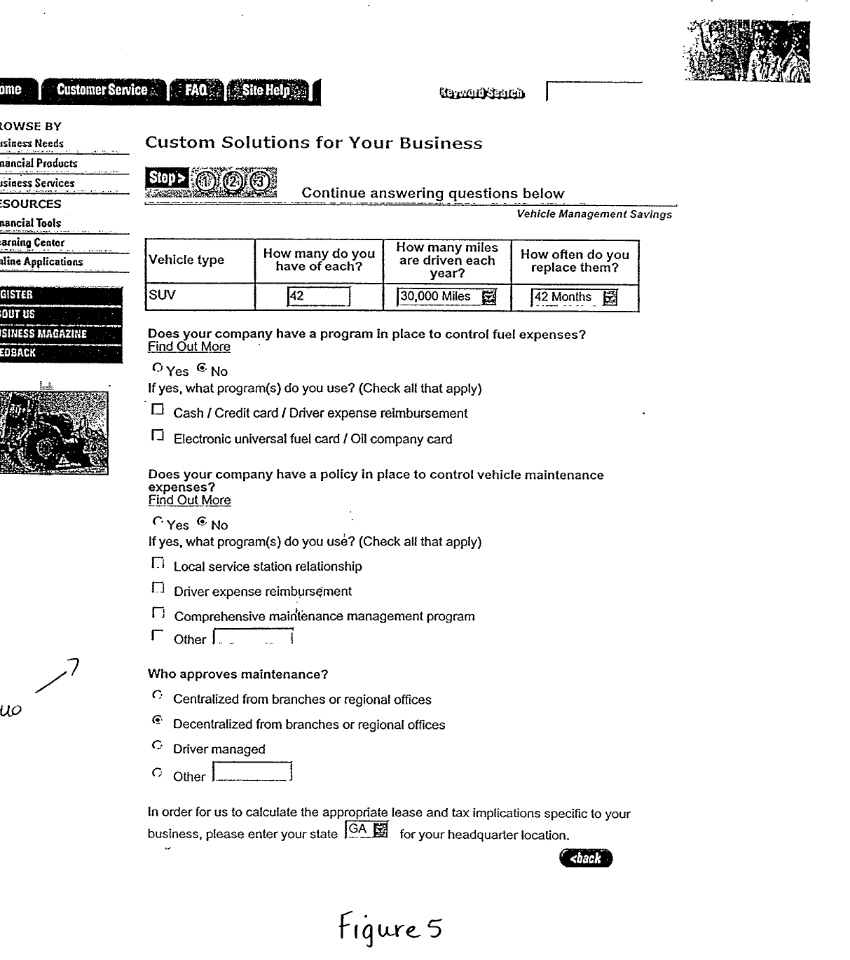

When the user 14 accesses 30 the system, the user 14 may be presented immediately with an information gathering screen 40 as illustrated in FIGS. 4 and 5. Screen 40 may request the user 14 to provide information in relation to the way in which the client company currently, or is thinking about, manages its fleet of vehicles. The questions may include the following from FIGS. 4 and 5 or variations thereof.

How do you currently acquire your vehicles?

What funding sources has your company used to finance recent fleet purchases?

What resources do you use to dispose of your company's vehicles at replacement?

Does your company have a program in place to control fuel expenses?

Does your company have a policy in place to control vehicle maintenance expenses?

Who approves maintenance?

As illustrated the user may enter in answers to these questions by entering in data or checking off one or more of a list of selections. Entering in certain specific information, such as the types of vehicles in the fleet, may enable the system to provide a more customized consultative proposal.

Once the user has entered in answers to each of the above questions, the user may be prompted to provide further information. For example, the system may query the user 14 to enter the total number of vehicles of each type the fleet has, or is considering, in addition to how many miles these vehicles are driven and how often they are replaced. Knowing how many miles each different type of car is driven enables the system to customize information based on the average cost per mile of that vehicle type, the average maintenance cost of that vehicle type, and the cost of replacing that vehicle type in addition to comparisons with historical data tracked by the fleet company.

Same questions, such as the query concerning vehicle type, may have a link to a pop-up window or alternative screen. This pop-up window may provide further instruction on how to answer the question. For the vehicle type, it may provide examples of each type of vehicle to help the user correctly classify the vehicles in the fleet.

Thus, the system produces an accurate and quick estimate based on a limited amount of information. The system uses the database 20 to make accurate estimates based on a limited amount of input information. Utilizing a relatively low number of questions, for example less than 10, to formulate a complete consultative proposal reduces the time that the user 14 must sacrifice to evaluate the potential cost saving that may be achieved by utilizing the fleet company's services.

The system allows an accurate and valuable consultative solution to be generated based on the limited input of information received from user 14. Alternative embodiments of the present invention could query for more information to generate even more savings proposal or other types of information.

Once the information has been input into the information gathering screens 40, the system then will perform a series of calculations based on that information. Utilizing standard calculations, the system will generate a projected cost savings for various categories including alternative methods of vehicle acquisition, financing, maintenance, fuel acquisition, registration, or vehicle resale. In other embodiments, the system may include more categories of savings information based on more questions and information gathered from the client. These categories of dynamic and personalized calculations will then be integrated with static and standard proposal information into a customized consultative cost savings proposal.

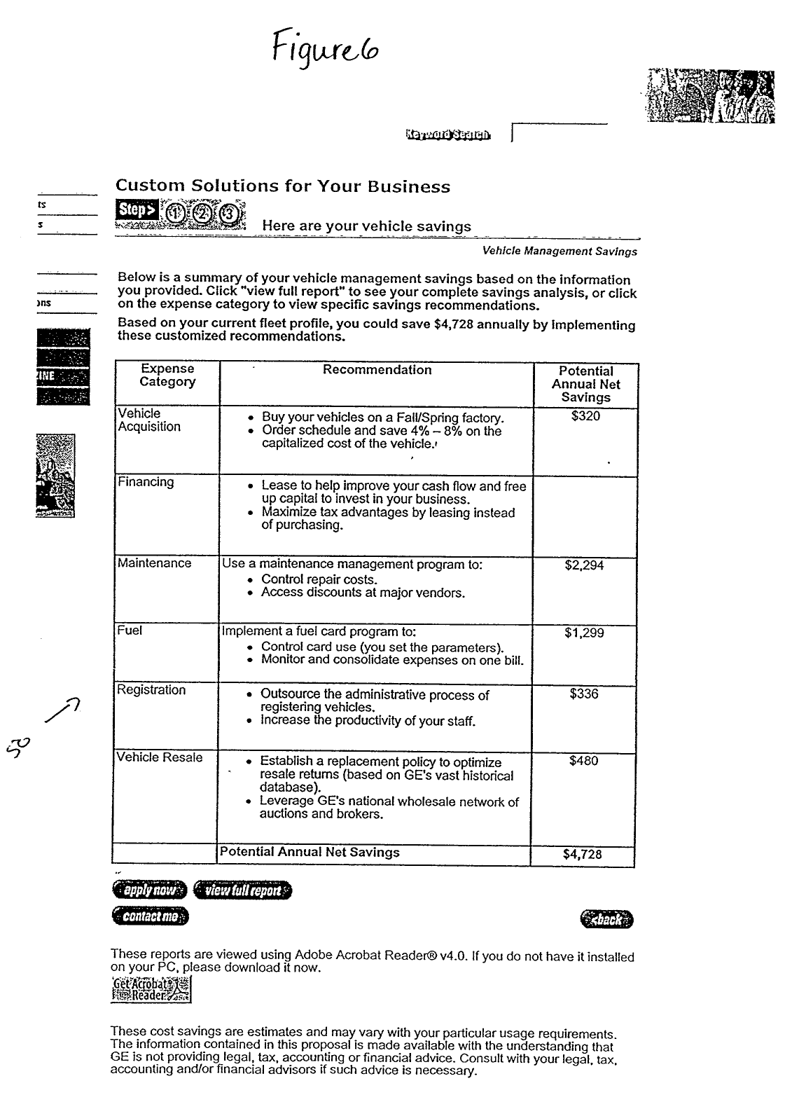

A static and dynamic consultative proposal then is quickly generated. FIG. 6 shows a sample prefatory page 50 that may be shown before the actual consultative proposal is selected. Prefatory page 50 may summarize the potential cost savings that are available and may entice the client to continue and look at the proposal more carefully.

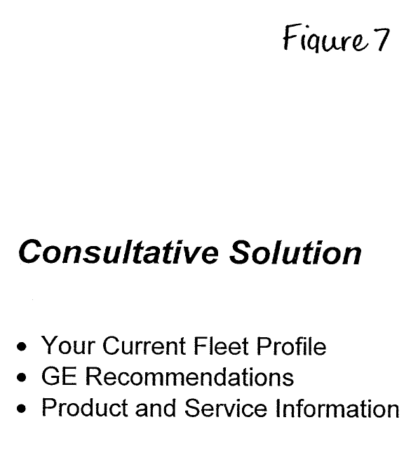

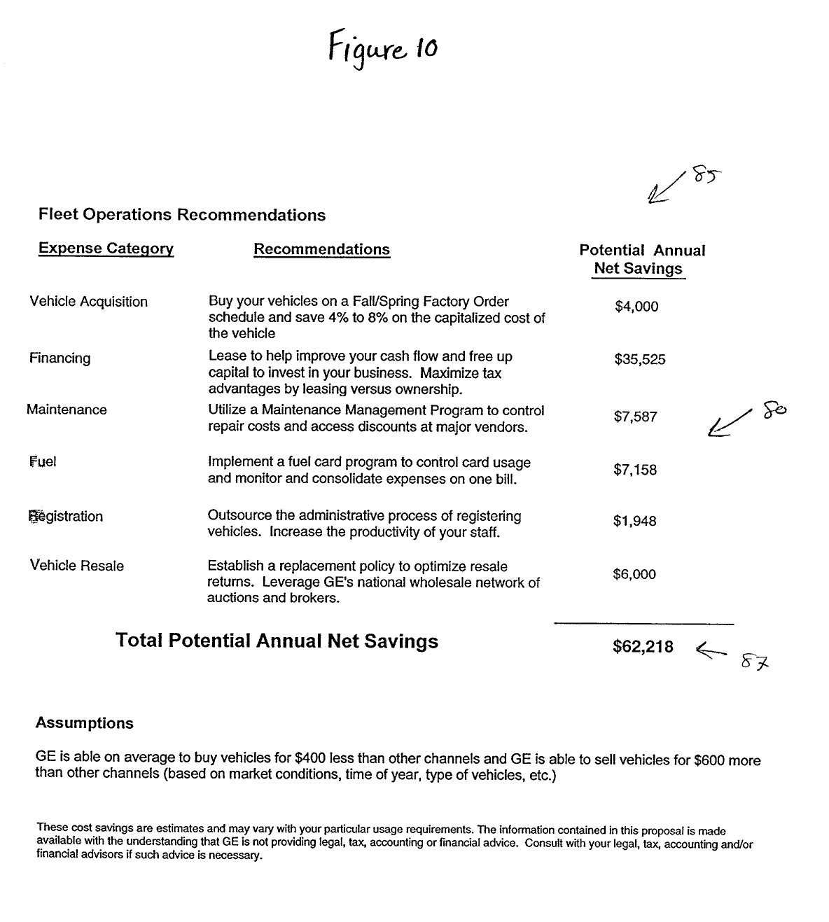

FIGS. 7-28 illustrate the merging of the customized dynamic calculation data with static consultative and promotion templates. FIGS. 7-28 are samples of one entire consultative proposal generated based on static information and the results of calculations based on the dynamic client entered information. The consultative proposal may be longer, shorter, and/or include more static information depending on the client input information and on the categories of potential cost savings information. For example on FIG. 10, illustrates the potential annual net savings 80 that are possible in each of the selected categories. Different categories of possible savings information may be relevant to different types of vehicle fleets. In alternative embodiments the present invention may be utilized to generate quotes for several different vehicle categories.

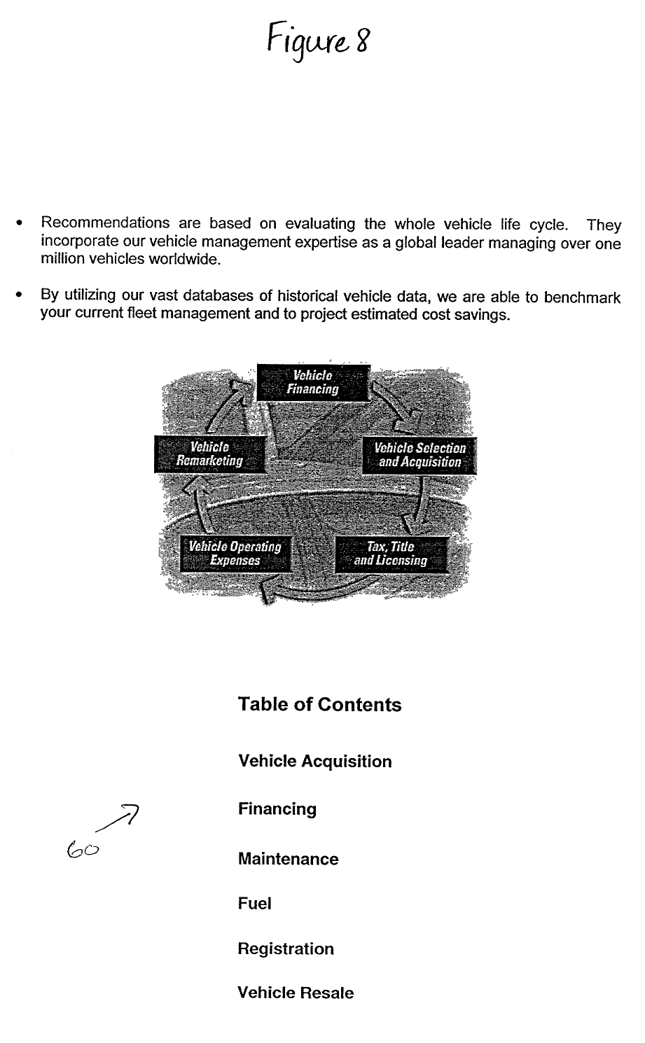

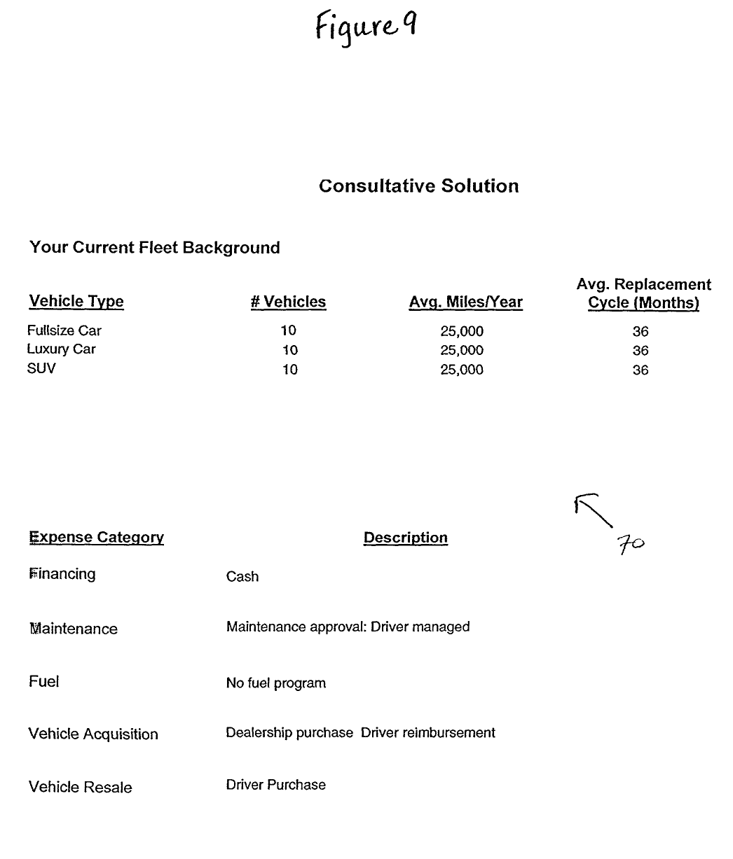

In FIGS. 8-10 the categories and information that appear may be dependant upon the information entered by the user, and upon the calculations done by the fleet company database. The table of contents 10 illustrated in FIG. 8 reflect the categories that the system determine are possible areas where savings could be generated depending on a change in the manner in which the client runs its fleet. FIG. 9 illustrates the information 70 as input from the information gathering screens 40.

FIG. 10 illustrates a summary screen 85 for the potential annual net savings 80. As illustrated in the FIG. 10, the data may be presented in such a manner as to highlight the potential annual net savings 80 for each category, with the total annual net savings listed at the bottom 87. The information presented on this and other screens may be put forth in almost any manner desired by the fleet company, highlighting different portions of the consultative proposals as situations warrant. In other embodiments, the database 20 may have a series of different static promotional material formats for the dynamic calculation information to be presented. Placing the proposals in different formats may highlight areas where savings are the greatest, providing a more effective consultative proposal. The different formats may be chosen by an automatic system that compares the numbers that result from the calculations to ranges for different static proposal templates.

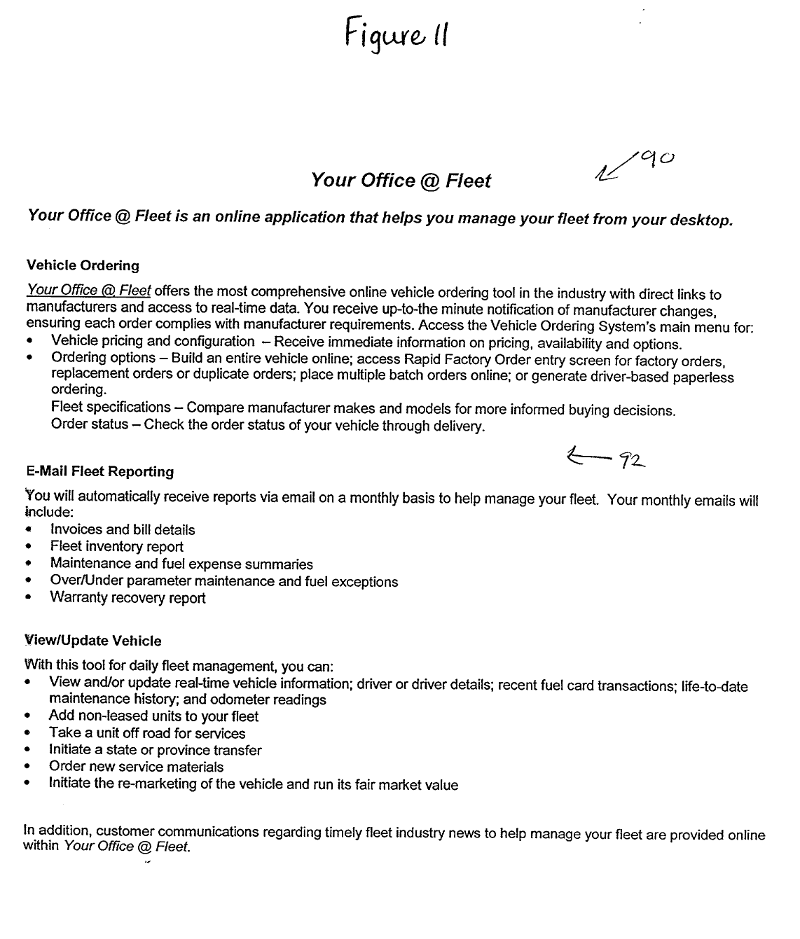

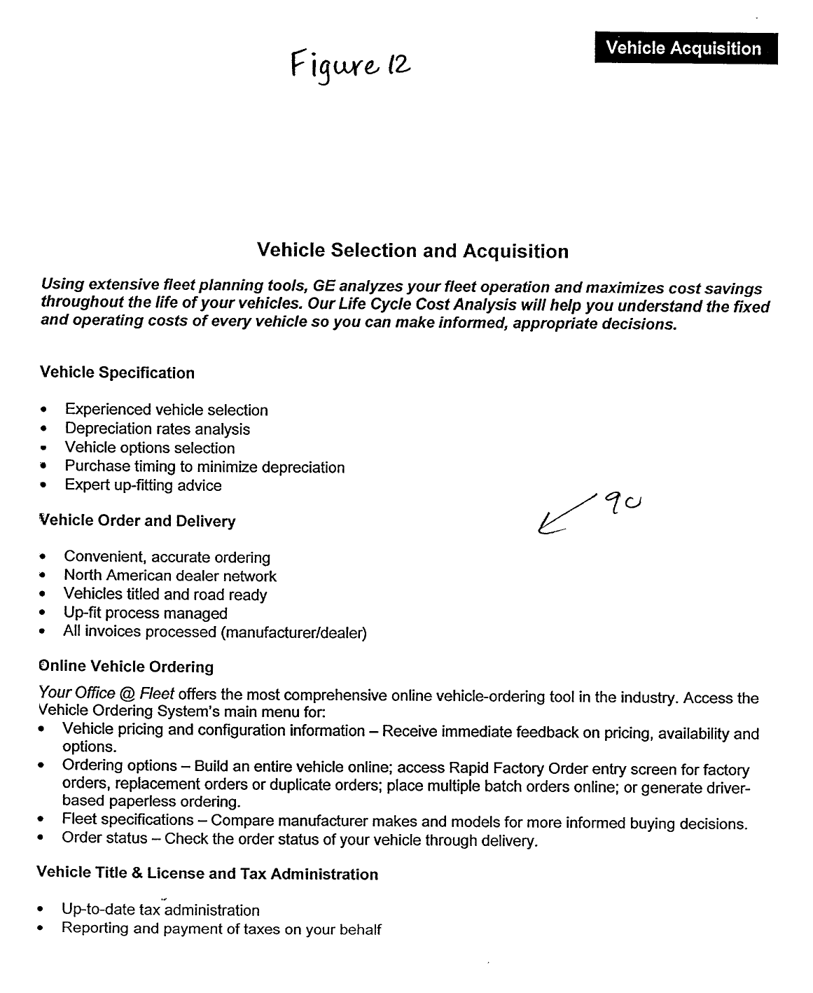

As illustrated in FIGS. 11-12, a number of screens that only present static promotional material 90 may be provided. This information may be integrated in such a manner by the fleet company that allows the consultative proposal to appear to be generated just for the client, and at the same time, provide significant information about the fleet company's services. FIG. 11 a promotional screen 92 for other services provided from the same company. This screen 92 may be utilized to advertise services provided by the fleet company that work in conjunction with the system, enabling the client to evaluate even more cost saving information. FIG. 11 may represent the first page of the static promotional material that relates to one specific category selected by the database and shown in the table of contents.

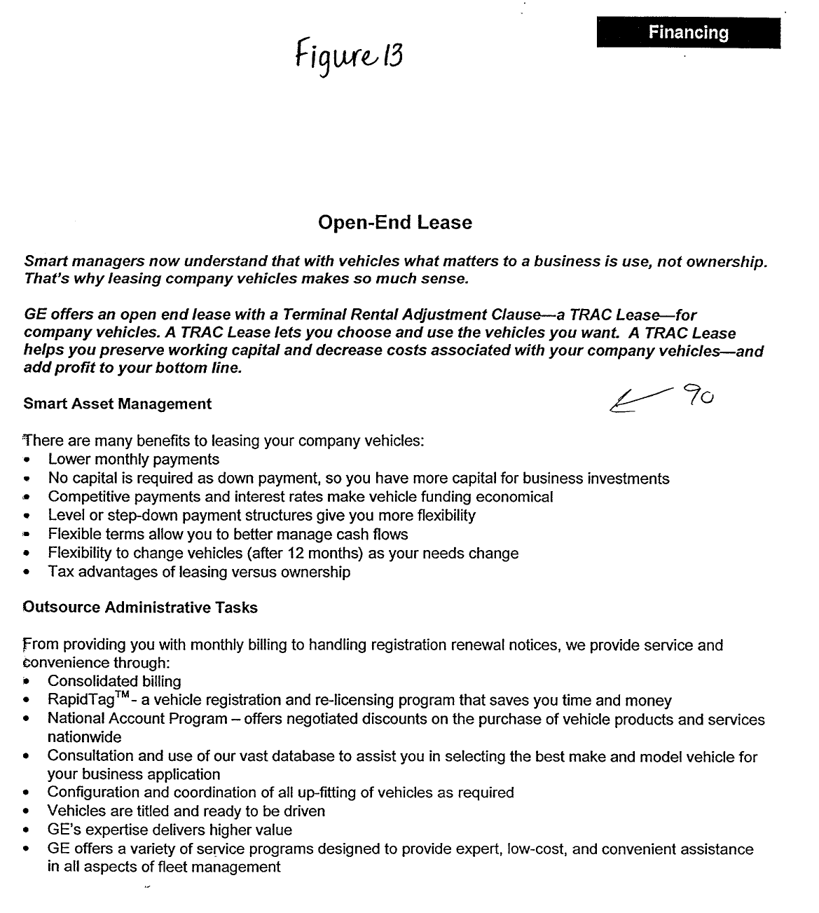

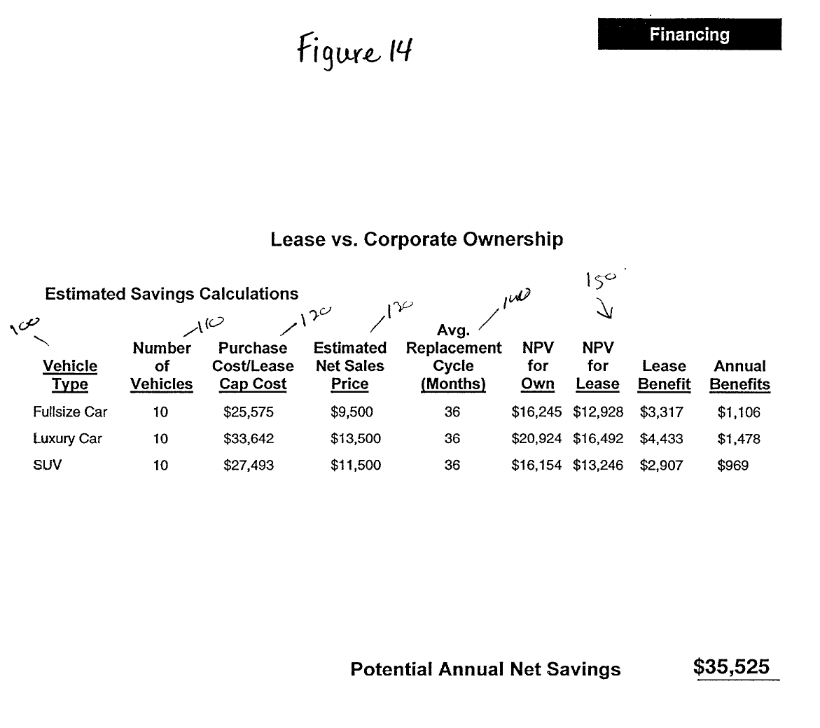

FIGS. 12-14 show the first category that has been selected to present. FIG. 12 represents acquisitions. FIGS. 13-14 include static information 90 incorporated into the results customized calculations for the client, that deal with financing.

FIG. 14 illustrates evidence of actual cost savings for the financing category. The system breaks down the information by vehicle type 100, number of vehicles 110, purchase price 120, sales price 130, replacement cycle 140, as well as other information 150. The spreadsheet layout of FIG. 14 may be particularly helpful when analyzing the consultative proposal to arrive at the total annual benefits for each category of vehicle, and then the total potential annual savings for the change in financing in general. As with any of the proposal screens, the information may be presented in a variety of other ways.

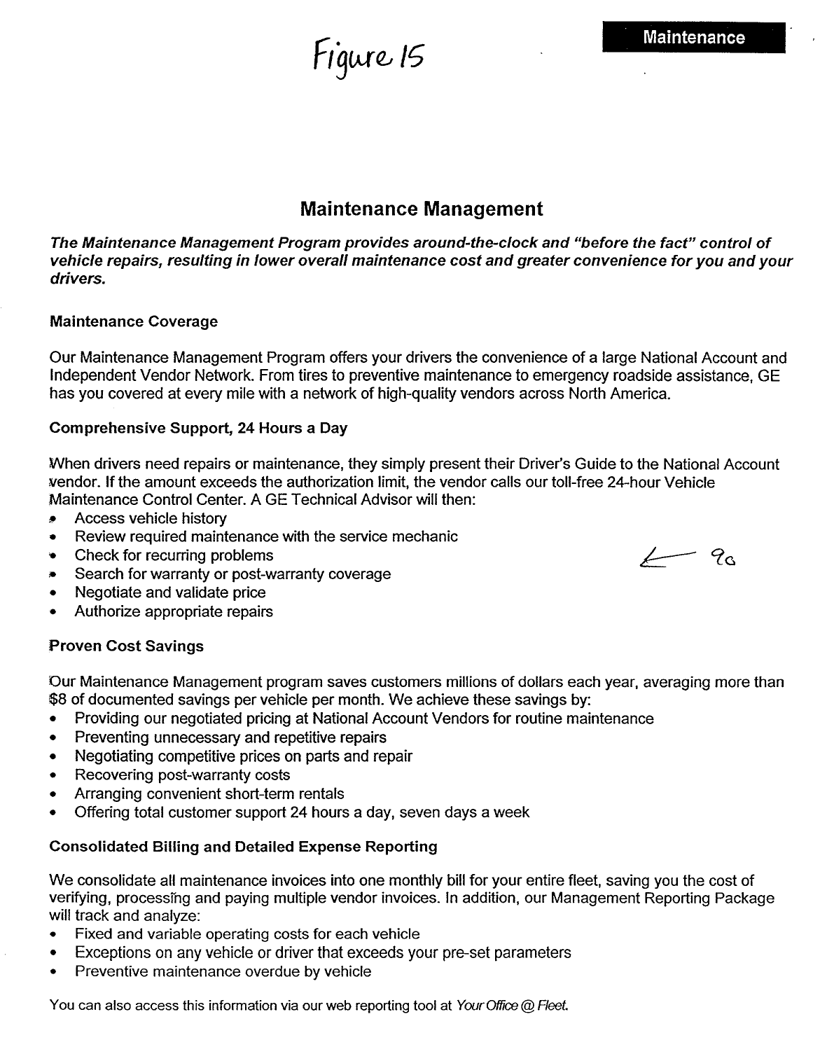

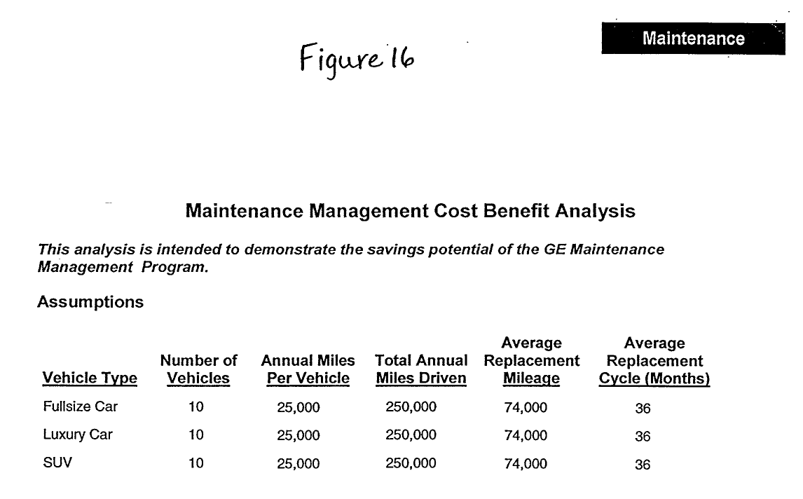

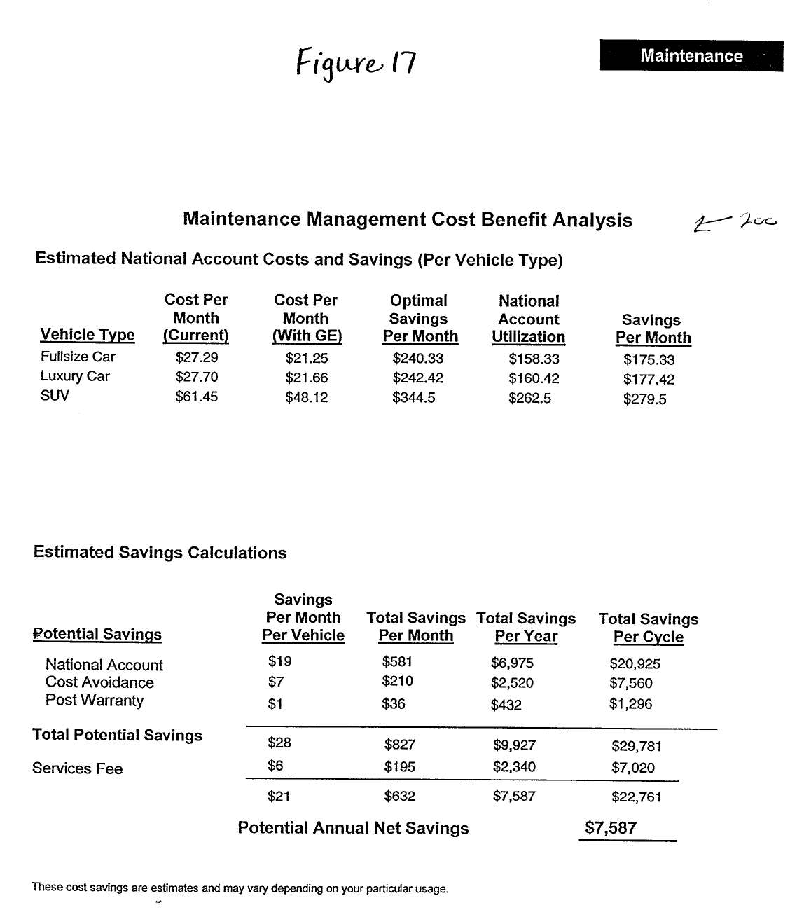

FIGS. 15-18 show information related to maintenance management. FIG. 15 shows standard static promotional materials 90 inserted into by the database. FIG. 16 repeats the information entered by the user 14 client, including the type of vehicle, the number of each vehicle type, the annual miles driven per vehicle, the total annual miles, and any other information. This information projects the estimates so the client can make a comparison to any records the client might have kept in the past. FIG. 17 is a maintenance management analysis 200 screen that lays out the information relating to cost savings from maintenance management by the fleet company including the potential annual net savings.

FIG. 17 shows the cost per vehicle on national basis for maintenance if provided by the fleet company. Comparisons of the estimated cost per month to the cost per month if the client were to utilize the fleet company's maintenance services may be provided for each type of vehicle. This cost estimate may then be totaled for all of the vehicles, thus illustrating the total savings per cycle of each vehicle and the total savings per year of the entire program.

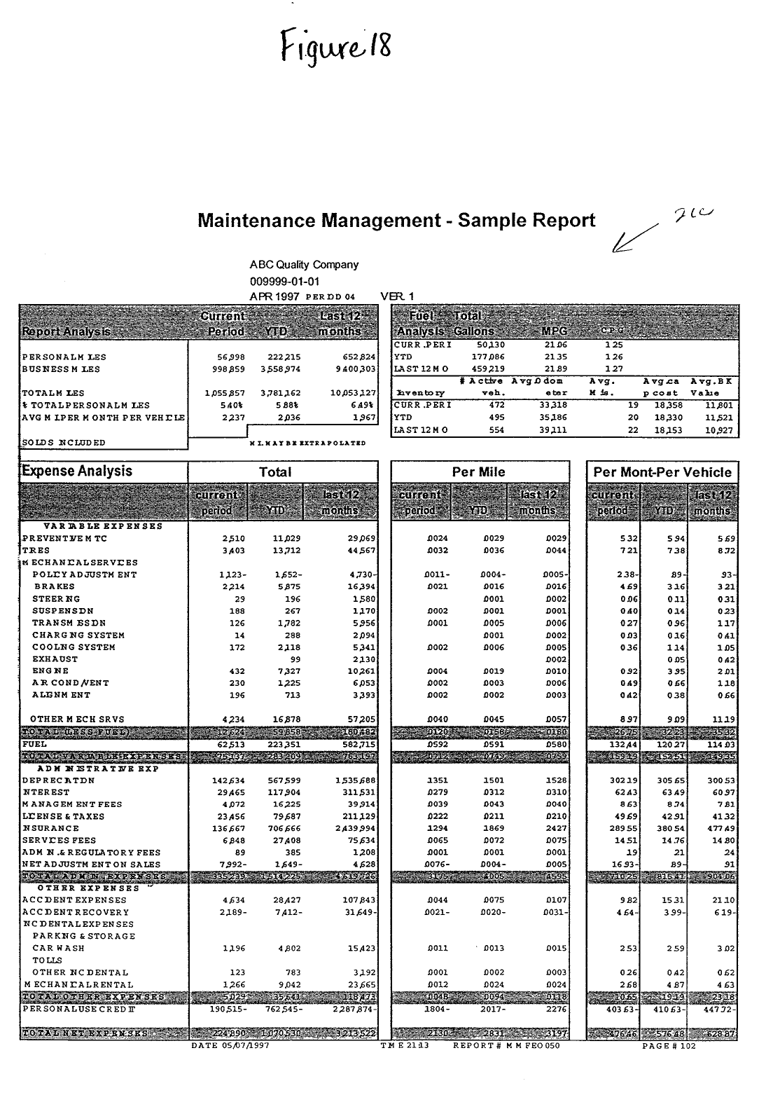

FIG. 18 illustrates a static example of a cost inventory 210 provided by the fleet company when it manages a vehicle fleet. Such information as variable expenses for each type of vehicle service, depreciation costs for each vehicle, administration expenses, regulatory expenses, and other pertinent information to the maintenance of a vehicle may be presented in an organized fashion. Static display examples like that illustrated in FIG. 18 in the customized proposal may help to provide the client with more information about the fleet company's services.

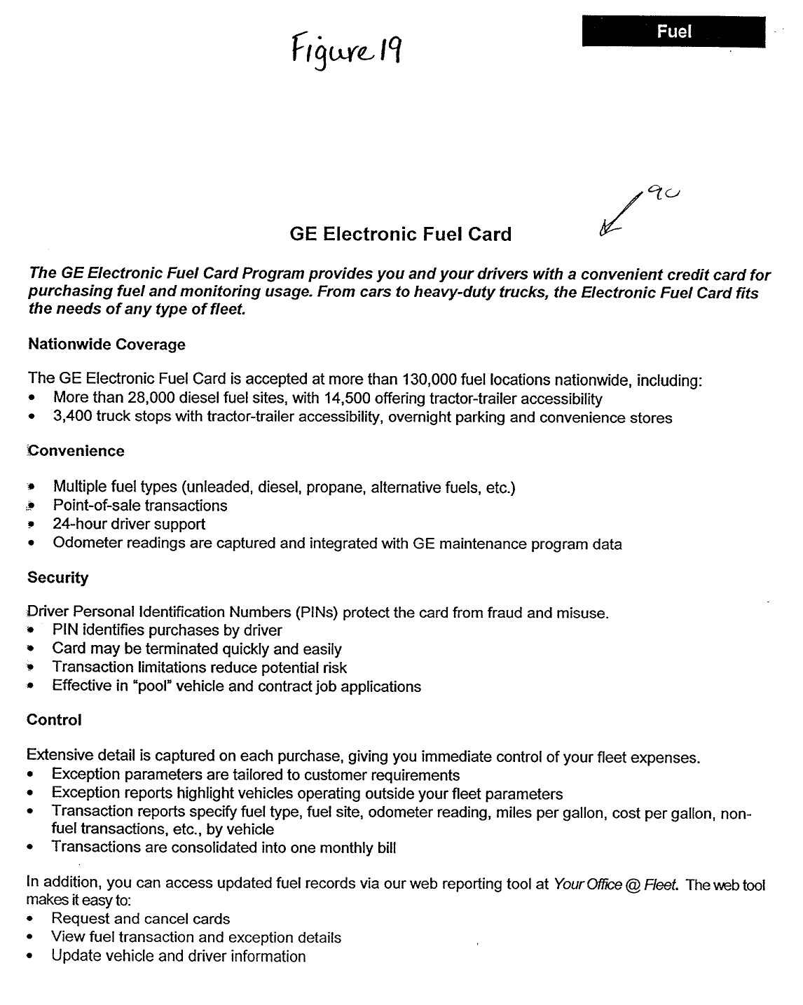

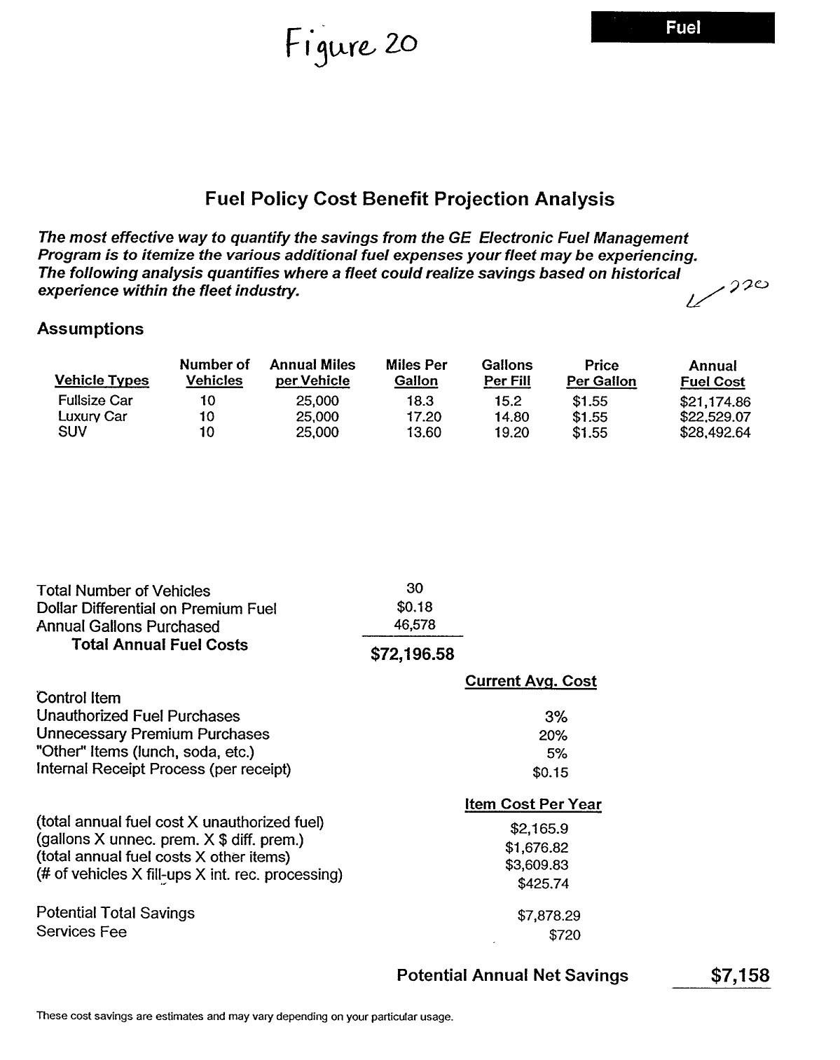

FIGS. 19-24 illustrate the dynamic and static estimated savings related to fuel. FIG. 19 is again a static information 90 and promotional material screen. It displays the information that may be provided by the fleet company when the client company utilizes fleet company's fuel management services. Such features as nationwide coverage, convenience, security, control and tracking may be provided by such a system. FIG. 20 may be a layout of the average cost savings 270 per vehicle estimated on the mileage per gallon of each type of vehicle and may include historical date by type of vehicle. This dynamic consultative calculation may be the result of the information the client has entered in the beginning, compared with the estimated fuel costs that may result without using fleet management. This information may include estimates for abuse of other fuel management systems that may be avoided by using the fleet company's services. Providing such dynamic information in the customized proposal along with other static functional materials help the present invention to provide a more effective customized proposal.

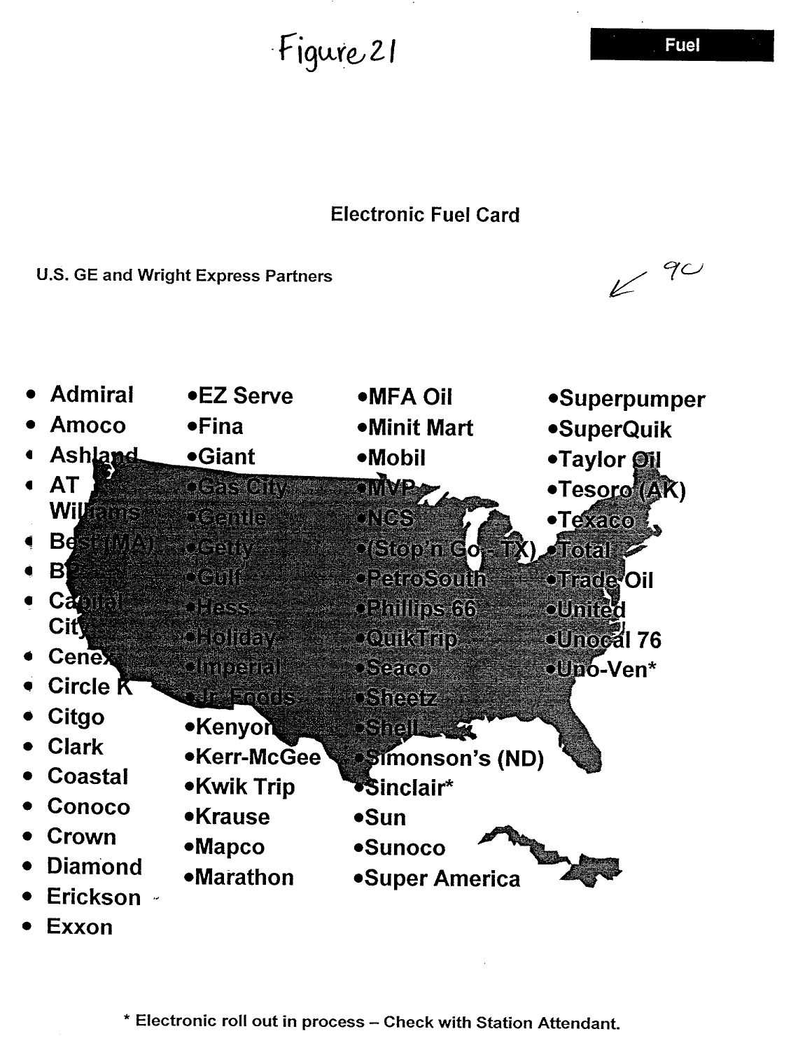

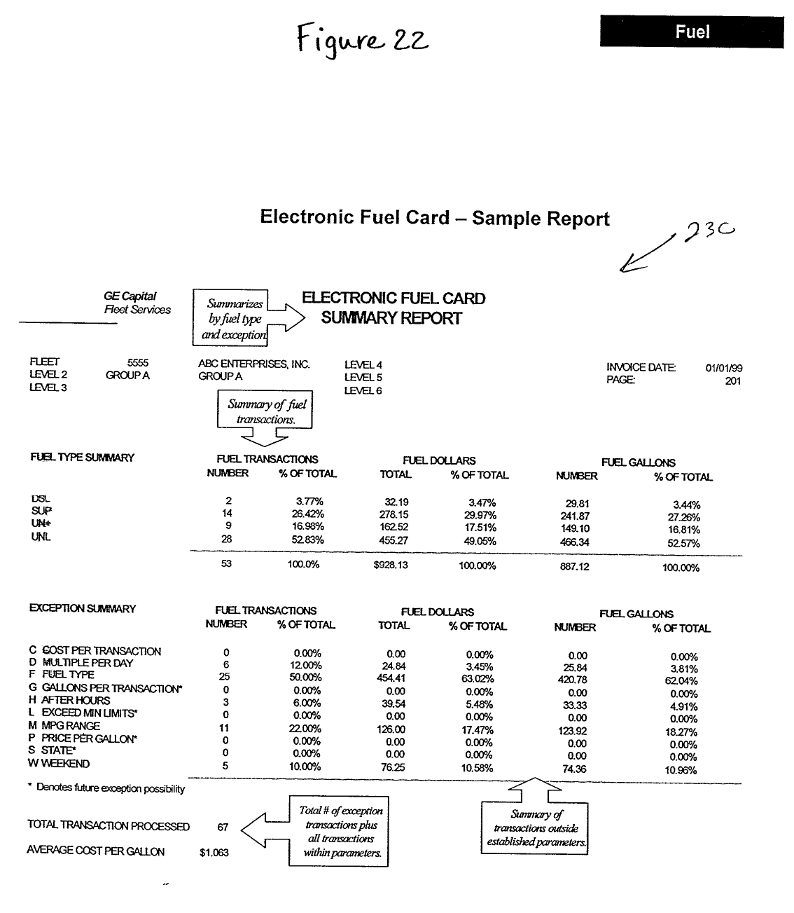

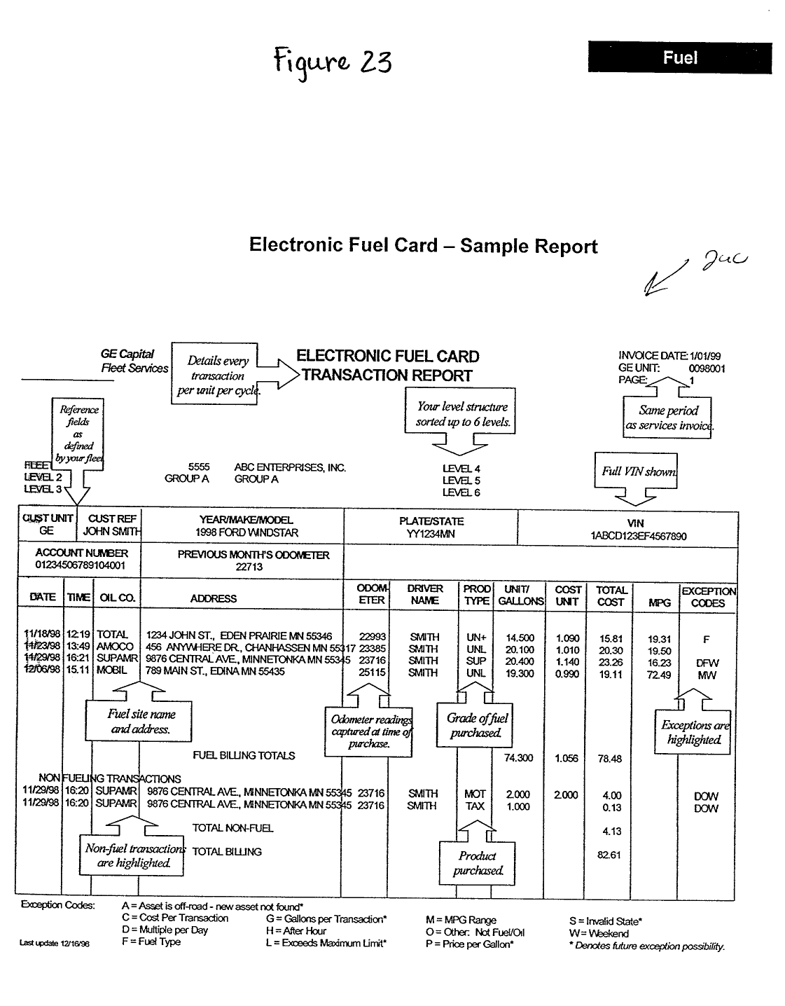

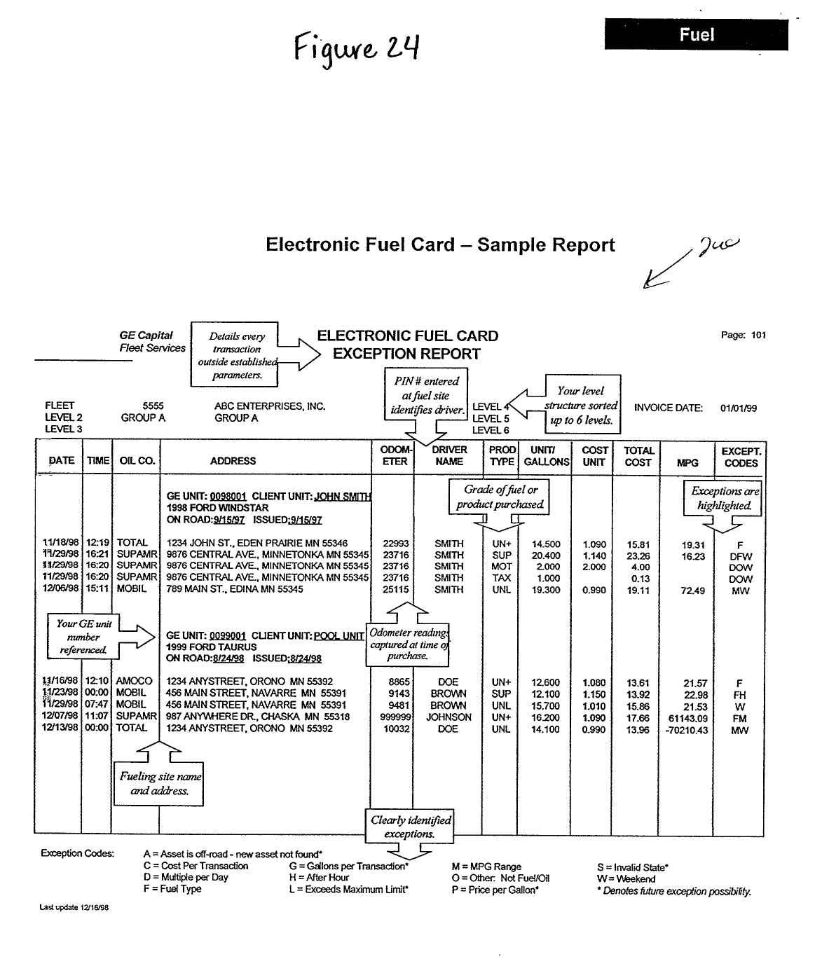

FIG. 21 may be further static information 90 related to the fleet company's services, illustrating those companies that are partnered with the fleet company. FIG. 22 illustrates a static sample fuel card report 230. Sample fuel card 230 illustrates how the fleet company can present the client with an organized and itemized monthly report, showing the total expenditures made on fuel and other sundries that have been placed on the fleet company's card. As before, static examples integrated with the cost savings information based on the client's own input may provide an effective customized proposal. Sample fuel card report 230 includes such information as the gas station, the time, the date, the odometer reading, the driver name, and other non-fueling transactions. FIGS. 23 and 24 illustrate alternative static screen sample reports 200 for the fuel card that may be provided by the fleet company.

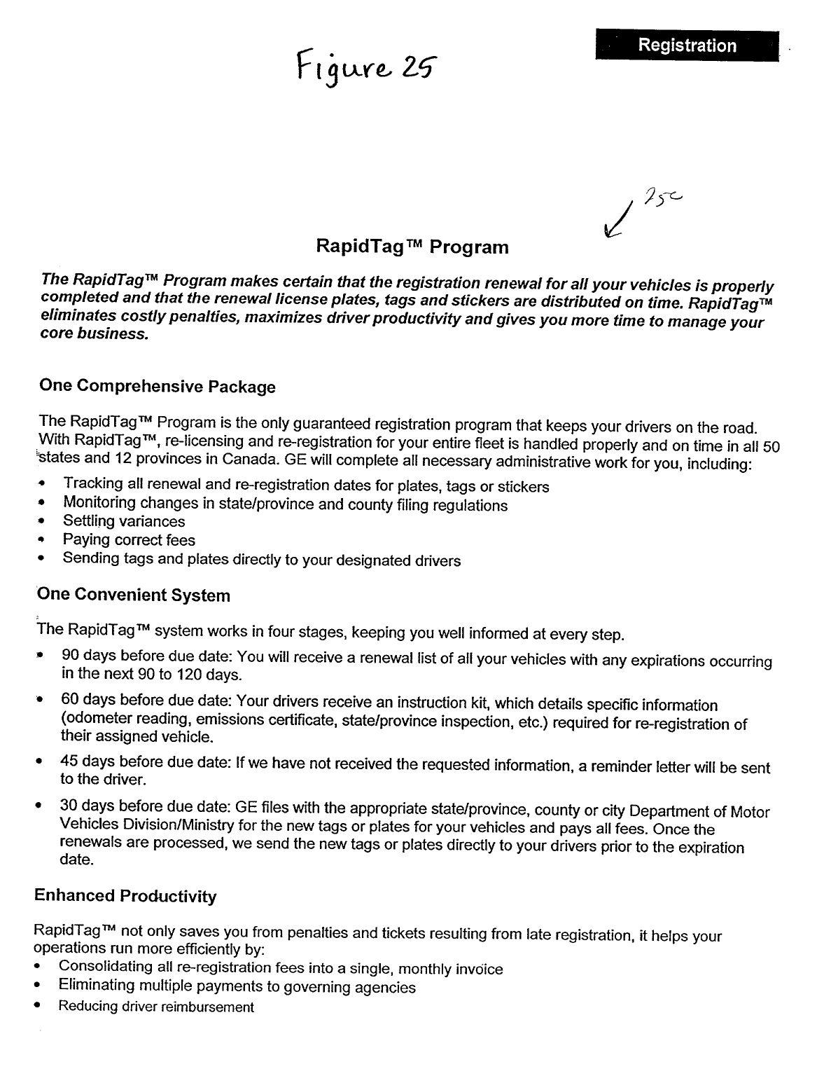

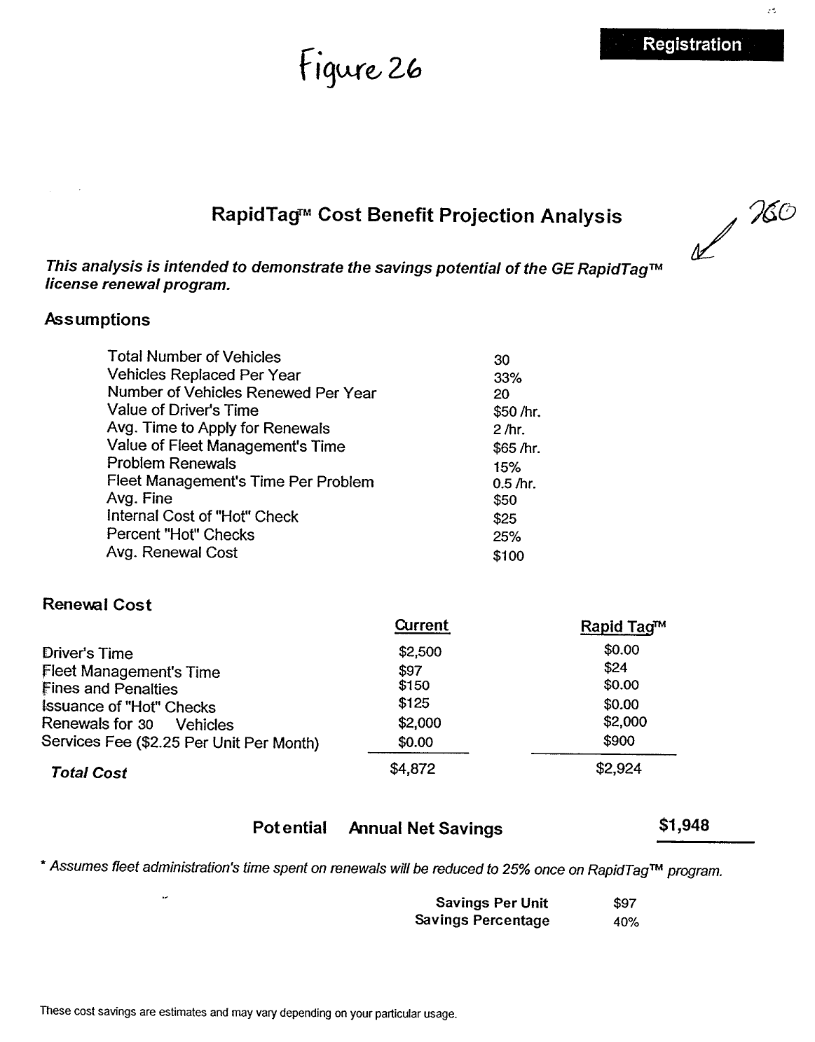

FIGS. 25-26 illustrate another sample program presented to user 14. Again, the system integrates both static and dynamic information in one consultative proposal. FIG. 25 is a static rapid tag™ report 250 that describes and illustrates the services that may be available to the client company's fleet if they work with the fleet company for registering their vehicles with the governmental authorities. FIG. 26 illustrates cost benefit analysis 260 including the assumptions made for the analysis and shows the cost estimate for each vehicle in the client's fleet. The information illustrates how much the client might save per year on the client's entered fleet information.

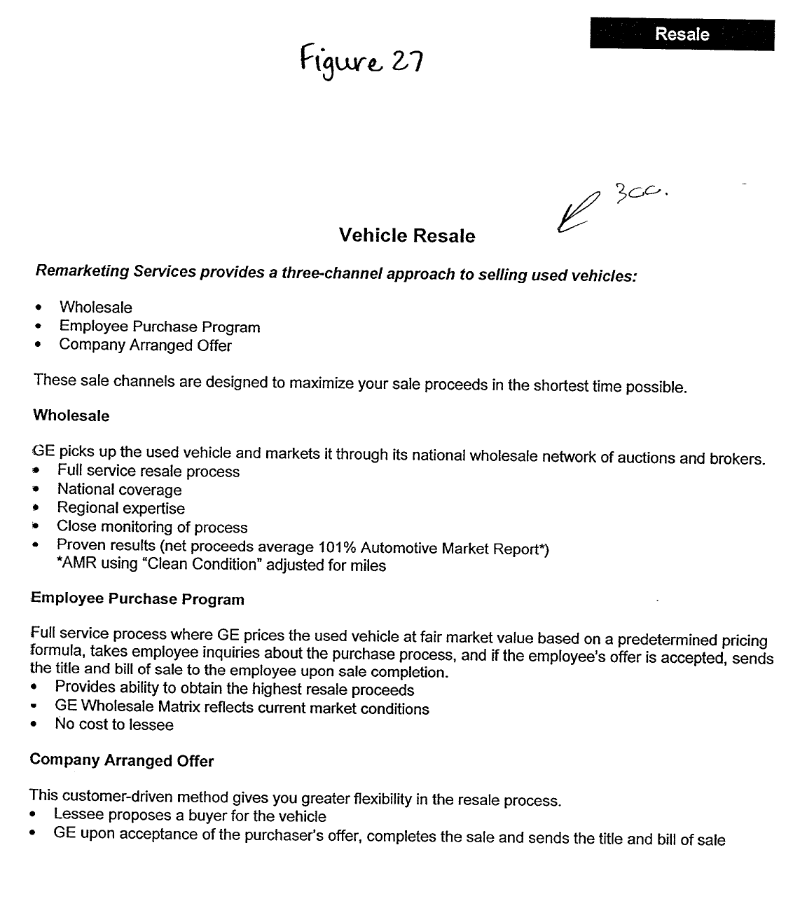

FIG. 27 illustrates vehicle resale information screen 300 generated from static information. Vehicle resale screen 300 presents information on how the fleet company may provide services that can maximize the dollar return for each vehicle the client wishes to detach from its fleet. The information listed does not integrate any dynamic information specific to the client, but in alternative embodiments may project average return compared to an assumption analysis similar to the estimates for fuel savings illustrated above. In alternative embodiments the estimated cost savings figures may be based on the types of vehicles, the miles on each vehicle, the age of each vehicle, and show the increased amount the fleet company may be able to provide the client in returns on each vehicle.

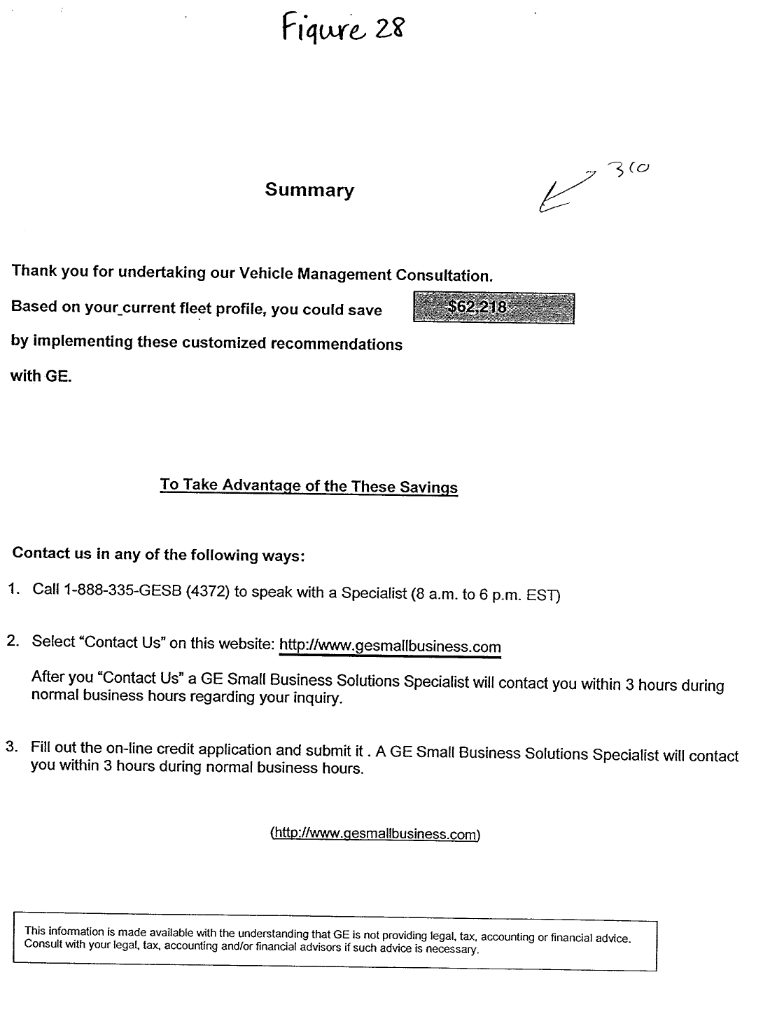

FIG. 28 illustrates a summary page 310 that may reiterate the amount of costs savings and may remind the client how to take advantage of the proposed cost savings utilizing the fleet company's services. Summary page 310 may change for each alternative embodiment and provide further information on the services that the fleet company provides.

The system thus provides a rapid way of generating consultative promotional materials illustrating the cost saving benefits of the fleet company. Additionally the system and method may almost immediately, with calculations embedded in the system, provide the client with an estimate on annual monetary savings if the client were to utilize the fleet company's services.

The system automatically integrates static information and promotional materials about the fleet company with dynamic information based on client input. The dynamic information entered by the customer may be the basis for any number of calculations to arrive at cost savings estimates, and thereafter integrated into the promotional materials, charts, and layouts that emphasize the potential cost savings if the client were to utilize the fleet company's services.

With this system the proposal may be provided automatically over the Internet to the client in an expeditious manner. Thus, a client who is searching for ways to reduce the costs associated with maintaining a fleet of vehicles may easily evaluate the options. The client does not need to travel or to make contact with a salesperson of the fleet company to evaluate the advantages of working with the fleet company. No lengthy questionnaires must be filled out and no wait time for estimates is needed.

The system allows for a reduction in the costs that the fleet company must expend to estimate potential cost savings for a potential client. Providing the fleet company with a method of reducing costs associated with preparing consultative proposals for potential clients allows the fleet company to even further reduce the costs for their client company's fleets.

The system has been described in terms of a fleet of vehicles used for transportation. In alternative embodiments, the system may be utilized to produce consultative proposals for other types of vehicles and equipment, such as construction equipment, trucking equipment, maritime shipping equipment, or even airline equipment. As may be appreciated by one skilled in the art, being able to generate a fast, accurate, and customized proposal utilizing calculations based on dynamic user input, and merging it with standardized promotional materials may have application in a variety of different consultative applications. Furthermore, different embodiments of the present invention may be based on different type of decision making logic commands and calculations also without changing the nature and scope of the present invention.

While the present invention has been described with reference to several embodiments thereof, those skilled in the art may recognize various changes that may be made without departing from the spirit and scope of the claimed invention. Accordingly, this invention is not limited to what is shown in the drawings and described in the specification. Any number or ordering of the elements is merely for convenience and is not intended to suggest that the ordering of the elements has any particular significance other than that otherwise explicitly expressed.

1. A method of forming a consultative proposal comprising:
generating a series of questions;
receiving responses to the series of questions;
calculating terms for portions of the consultative proposal;
combining the terms for portions of the consultative proposal with static information to form a completed consultative proposal; and
presenting the consultative proposal.

2. The method of claim 1, wherein no more than 10 questions are generated.

3. The method of claim 1, wherein the consultative proposal relates to vehicle fleet management.

4. The method of claim 1, wherein the questions are generated from a database and are transmitted over a computer network.

5. The method of claim 1, wherein calculating the terms includes providing an estimation of savings when using the services of a fleet management company based upon the responses received.

6. The method of claim 1, wherein presenting the consultative proposal includes transmitting and electronic file over a computer network, wherein the electronic file is capable of being displayed on an electronic device.

7. The method of claim 1, wherein presenting the consultative proposal includes transmitting a facsimile.

8. The method of claim 1, wherein presenting the consultative proposal includes delivering a hard copy.

9. A method of forming a consultative proposal comprising:
providing a series of questions regarding a fleet of vehicles over a computer network to a user terminal;
receiving a response to the series of questions in an electronic format;
calculating potential savings for the operation of a fleet of vehicles based upon data stored within a database and the response received;
combining the calculated potential savings along with static promotional material to form a completed consultative proposal; and
presenting the consultative proposal.

10. The method of claim 9, wherein the questions include a question regarding how the user acquires vehicles.

11. The method of claim 9, wherein the questions include a question regarding how the user funds fleet purchases.

12. The method of claim 9, wherein the questions include a question regarding how fleet vehicles are disposed of by the user.

13. The method of claim 9, wherein the questions include a question regarding the types of vehicles in the fleet.

14. The method of claim 9, wherein the questions include a question regarding how fuel expenditures are handled.

15. The method of claim 9, wherein the questions include a question regarding how maintenance expenses are handled.

16. The method of claim 9, wherein the questions include a question regarding which jurisdiction the fleet is in for tax purposes.

17. The method of claim 9, wherein the consultative proposal is electronically generated and presented to the user nearly instantaneously.

18. The method of claim 9, wherein no more than 10 questions are generated.

19. A system for generating consultative proposals comprising:
a database for storing static promotional material, criteria for calculations and questions related to fleet management; and
a computer having software running thereon to generate a series of questions related to fleet management from the database, transmit the questions to a remote terminal, receive responses to the questions, perform calculations based on the criteria for calculation stored within the database, and generate a consultative proposal based upon the calculations and including at least portions of the static promotional material.

20. The system of claim 19 wherein the computer is a server remotely accessible via a computer network.

21. The system of claim 20 wherein the computer network is the Internet.

22. A computer readable medium having instructions thereon to cause a computer to:
generate a series of questions;
receive responses to the series of questions;
calculate terms for portions of the consultative proposal;
combine the terms for portions of the consultative proposal with static information to form a completed consultative proposal; and
present the consultative proposal.

23. The computer readable medium of claim 22, wherein no more than 10 questions are generated.

24. The computer readable medium of claim 22, wherein the consultative proposal relates to vehicle fleet management.

25. The computer readable medium of claim 22, wherein the questions are generated from a database and are transmitted over a computer network.

26. The computer readable medium of claim 22, wherein calculating the terms includes providing an estimation of savings when using the services of a fleet management company based upon the responses received.

27. The computer readable medium of claim 22, wherein presenting the consultative proposal includes transmitting and electronic file over a computer network, wherein the electronic file is capable of being displayed on an electronic device.

28. The computer readable medium of claim 22, wherein presenting the consultative proposal includes transmitting a facsimile.

29. The computer readable medium of claim 22, wherein presenting the consultative proposal includes delivering a hard copy.

30. A computer readable medium having instructions thereon to cause a computer to:
provide a series of questions regarding a fleet of vehicles over a computer network to a user terminal;
receive a response to the series of questions in an electronic format;
calculate potential savings for the operation of a fleet of vehicles based upon data stored within a database and the response received;
combine the calculated potential savings along with static promotional material to form a completed consultative proposal; and
present the consultative proposal.

31. The computer readable medium of claim 30, wherein the questions include a question regarding how the user acquires vehicles.

32. The computer readable medium of claim 30, wherein the questions include a question regarding how the user funds fleet purchases.

33. The computer readable medium of claim 30, wherein the questions include a question regarding how fleet vehicles are disposed of by the user.

34. The computer readable medium of claim 30, wherein the questions include a question regarding the types of vehicles in the fleet.

35. The computer readable medium of claim 30, wherein the questions include a question regarding how fuel expenditures are handled.

36. The computer readable medium of claim 30, wherein the questions include a question regarding how maintenance expenses are handled.

37. The computer readable medium of claim 30, wherein the questions include a question regarding which jurisdiction the fleet is in for tax purposes.

38. The computer readable medium of claim 30, wherein the consultative proposal is electronically generated and presented to the user nearly instantaneously.

39. The computer readable medium of claim 30, wherein no more than 10 questions are generated.
